(19) United States
(12) Patent Application Publication
(10) Pub. No.: US 2017/0026599 A1
(43) Pub. Date: Jan. 26, 2017

(54) Image Sensor Array and Arrangement Method Thereof, Image Acquisition Component and Electronic Device

(71) Applicant: Lenovo (Beijing) Co., Ltd., Beijing (CN)

(72) Inventors: Ke He, Beijing (CN); Jiefeng Chen, Beijing (CN)

(73) Assignee: Lenovo (Beijing) Co., Ltd., Beijing (CN)

(21) Appl. No.: 14/984,208

(22) Filed: Dec. 30, 2015

(30) Foreign Application Priority Data
Jul. 20, 2015 (CN) 201510427354.9

(51) Int. Cl. H04N 5/378; G02B 27/00; H04N 5/225

(52) U.S. Cl. CPC H04N 5/378; H04N 5/2253; H04N 5/2254; G02B 27/0025

(57) ABSTRACT

An arrangement method of an image sensor array includes forming an M-row N-column non-standard rectangular pixel array with M×N image sensors, wherein the non-standard rectangular pixel array matches to optical distortion of an associated lens. The non-standard rectangular pixel array refers to that four edges of the non-standard rectangular are curves, and the M, N are an integer larger than or equal to 1. An image sensor array, an image acquisition component, and an electronic device are also described.

This application claims priority to Chinese Patent Application No. 201510427354.9 filed Jul. 20, 2015, the entire contents of which are incorporated herein by reference.

The present application relates to the field of electronic technique, and more particularly, to an image sensor array and an arrangement method thereof, an image acquisition component, and an electronic device.

### BACKGROUND

Currently, a photographing function is one among must-have functions of an electronic device, such as a mobile phone, a tablet computer etc., and an image acquisition component, such as a camera, used for achieving the photographing function also becomes an essential functional component of the electronic device. The image acquisition component mainly comprises a lens, an image sensor, an Analog/Digital (A/D) converter, and a digital signal processing chip (DSP).

The lens is composed by an optical lens, the optical lens brings certain defects in imaging because of its own structure, e.g., it is circular and has a thick center and thin edges, this structure of the optical lens will bring a distortion problem to the imaging. FIG. 1A is a schematic diagram of imaging result of an optical lens in the related art. As shown in FIG. 1A, a square 21 will have an image 22 after passing through an optical lens 11, the pattern 21, a square originally, suffers from a distortion after passing through the optical lens 11, since four edges of the image 22 are no more straight lines and two adjacent edges no more intersect with a right angle, the image 22 is no more a square.

In addition, another problem caused by the above structure of the optical lens is the uneven relative illumination, that is, light will converge after incident light passes through the optical lens, so that a subject located in the center of the optical lens has a higher imaging definition through the optical lens, while a subject located at the edges of the optical lens has a lower imaging definition through the optical lens.

According to the above description, it is known that the image acquisition component in the art will bring the distortion problem and the uneven relative illumination problem due to the structure of the optical lens itself. How to eliminate the distortion and the uneven relative illumination have become the urgent problems to be solved.

### SUMMARY

In a first aspect, an embodiment of the present application provides an arrangement method of an image sensor array, comprising:

forming an M-row N-column non-standard rectangular pixel array with M×N image sensors, wherein the non-standard rectangular pixel array matches to optical distortion of an associated lens, the non-standard rectangular pixel array refers to that four edges of the non-standard rectangular are curves, and the M, N are an integer larger than or equal to 1.

In an embodiment of the present application, pixel sizes in the non-standard rectangular pixel array gradually increase from center to corners.

In a second aspect, an embodiment of the present application provides an image sensor array, comprising M×N image sensors, wherein

the M, N are an integer larger than or equal to 1;

the M×N image sensors form an M-row N-column non-standard rectangular pixel array, the non-standard rectangular pixel array referring to that four edges of the non-standard rectangular are curves;

the non-standard rectangular pixel array matches to optical distortion of an associated lens.

In an embodiment of the present application, pixel sizes in the non-standard rectangular pixel array gradually increase from center to corners.

In a third aspect, an embodiment of the present application provides an image acquisition component, comprising an image sensor array and a lens, wherein:

the lens is formed with an optical lens;

the image sensor array includes M×N image sensors, the M, N being an integer larger than or equal to 1;

the M×N image sensors form an M-row N-column non-standard rectangular pixel array, the non-standard rectangular pixel array referring to that four edges of the non-standard rectangular are curves;

the non-standard rectangular pixel array matches to optical distortion of the lens.

In an embodiment of the present application, pixel sizes in the non-standard rectangular pixel array gradually increase from center to corners.

In an embodiment of the present application, the image acquisition component further comprises an analog-to-digital converter, wherein:

the lens is configured to receive incident light reflected by a scenery, the incident light becoming outgoing light after passing through the lens;

the image sensor array is configured to receive the outgoing light from the lens, convert it into charge in accordance with intensity of the outgoing light, and form a current value of an analog signal;

the analog-to-digital converter is configured to convert the current value of the analog signal outputted by the image sensor array into a current value of a digital signal.

In a fourth aspect, an embodiment of the present application provides an electronic device, comprising a processor, a display screen, and an image acquisition component, wherein:

the image acquisition component comprises an image sensor array, a lens, and an analog-to-digital converter:

the lens is formed with an optical lens and configured to receive incident light reflected by a scenery, the incident light becoming outgoing light after passing through the lens;

the image sensor array comprises M×N image sensors, the M, N being an integer larger than or equal to 1; the M×N image sensors form an M-row N-column non-standard rectangular pixel array, the non-standard rectangular pixel array referring to that four edges of the non-standard rectangular are curves; the non-standard rectangular pixel array matches to optical distortion of the lens;

the image sensor array is configured to receive the outgoing light from the lens, convert it into charge in accordance with intensity of the outgoing light, and form a current value of an analog signal;

the analog-to-digital converter is configured to convert the current value of the analog signal outputted by the image sensor array into a current value of a digital signal, the current value of the analog signal being capable of forming an image;

the processor is configured to display the image on the display screen;

the display screen is configured to display the image.

In an embodiment of the present application, pixel sizes in the non-standard rectangular pixel array gradually increase from center to corners.

### BRIEF DESCRIPTION OF THE DRAWINGS

FIG. 1A is a schematic diagram of imaging result of an optical lens in the related art;

FIG. 1B is a schematic diagram of composing structure of an image sensor array according to a first embodiment of the present application;

FIG. 1C is a schematic diagram of a pixel array in the related art;

FIG. 1D is a schematic diagram of a pixel array provided by an embodiment of the present application;

FIG. 2A is a first schematic diagram of composing structure of an image acquisition component according to a second embodiment of the present application;

FIG. 2B is a second schematic diagram of composing structure of the image acquisition component according to the second embodiment of the present application;

FIG. 3 is a schematic diagram of composing structure of an electronic device according to a third embodiment of the present application;

FIG. 4A is a schematic diagram of matching process between a pixel array and a lens distortion in an embodiment of the present application;

FIG. 4B is a schematic diagram of comparison between the present application and the prior art in terms of RI;

FIG. 4C is a schematic diagram of comparison between the present application and the prior art in terms of MTF; and

FIG. 4D is a schematic diagram of a picture outputted by the pixel array according to an embodiment of the present application.

### DETAILED DESCRIPTION

As can be seen from the Background, the distortion problem and uneven relative illumination problem described above are caused by the structure of the optical lens itself. So long as the lens is implemented with an optical lens, there is no way to eliminate the above problems depending on the optical lens. But a picture desired by people is an image outputted after going through photoelectric conversion of the image sensor, if the image can be calibrated by the image sensor, then the above two problems are likely to be eliminated.

First, look at the conventional image sensor, the image sensor in the prior art almost all uses a matrix pixel arrangement and each pixel has the same size. The aforesaid structure and arrangement of the image sensor result in that it is impossible to solve the problems caused by the lens used for imaging, wherein the problems caused by the lens include:

1) Image Distortion, no matter how the lens is designed, it is impossible to completely solve the problem of image distortion.

2) Relative illumination (RI), now shading also becomes a performance issue of the image sensor whose pixels become smaller and smaller, because both an amount and an angle of light reaching different locations of the image sensor after passing through the lens are different, there appears a phenomenon that the illumination attenuates from center to corners, the smaller the pixel size is, the more obvious the shading phenomenon is.

3) Modulation Transfer Function, MTF, it is an important parameter used for describing definition, definition of the conventional optical design also shows a gradual attenuation process from center to corners, ensuring consistent definition throughout the whole picture is quite difficult.

Hereinafter, first, composition of an image acquisition component is introduced, the image acquisition component typically includes a lens, an image sensor, an Analog/Digital converter, and a digital signal processing chip (DSP). The image acquisition component works substantially based on the following principle: after the camera is enabled, light reflected by a scenery is propagated to the lens, an optical image generated by the lens is projected onto a surface of the image sensor, the image sensor accumulates corresponding charge in accordance with intensity of light, i.e. converting an optical signal to an analog electrical signal, which becomes a digital electrical signal after A/D conversion, then it is processed by the digital signal processing chip and becomes an image viewed by the user on a display.

The lens is composed by an optical lens, and is generally divided into a glass lens and a plastic lens based on material, a mainstream lens at present is a five-layer glass lens; the glass lens can acquire an image clearer than that the plastic lens. This is because the light passing through an ordinary glass lens usually has only 5% to 9% loss of light, and the light loss of the plastic lens is up to 11% to 20%. Some lens also adopts a multi-layer optical coating technique, which effectively reduces light refraction and filters noise, thereby improves a light through rate, resulting in a clearer image. In addition, the lens further has an important parameter, i.e., aperture, an amount of light reaching the image sensor through the lens can be controlled by adjusting the aperture, besides controlling the light through amount, the aperture also has a function of controlling depth of field, i.e., the larger the aperture is, the smaller the depth of field is.

The image sensor generally includes two types, CCD and CMOS, wherein advantages of CMOS, Complementary Metal-Oxide Semiconductor, are high integration, low power consumption (less than ⅓ of that of CCD), and low cost. But CMOS has high noise, low sensitivity, and high light requirements. CCD, Charge Coupled Device, may be divided into Linear CCD, Three-Line CCD, Area Array CCD, and Interleaving transmission CCD. Like human retina, CCD is a core of the image acquisition component. CCD is a semiconductor chip, its surface contains hundreds of thousands to millions of photodiodes, and the photodiodes will generate charge when being irradiated by light. Advantages of CCD are: high sensitivity, low noise, large signal to noise ratio, but its production process is complexity, cost is high, and power consumption is high. With the same pixels, CCD imaging often has very good permeability and sharpness, can ensure basic accuracy in terms of color reproduction and exposure. While CMOS's products often have ordinary permeability, color reproduction capability for a physical substance is weak, exposure is not very good either. CCD is composed by area array sensitive elements, each element is called a pixel, the more pixels there are, the clearer the image is.

The DSP chip generally includes an image signal processor (ISP) and a JPEG encoder, some DSP chip also includes a USB device controller.

Based on the foregoing description, an embodiment of the present application provides an image acquisition component, to eliminate the image distortion problem and the uneven relative illumination problem caused by the optical lens by changing a size and an arrangement manner of the image sensor in the prior art.

Hereinafter, the technical solutions of the present application will be further described in detail in conjunction with the accompanying drawings and the specific embodiments.

### First Embodiment

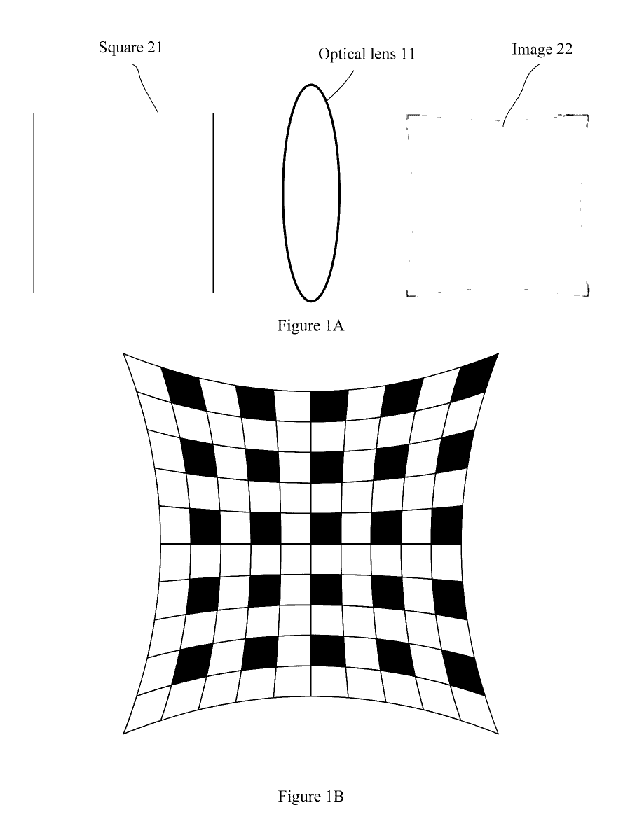

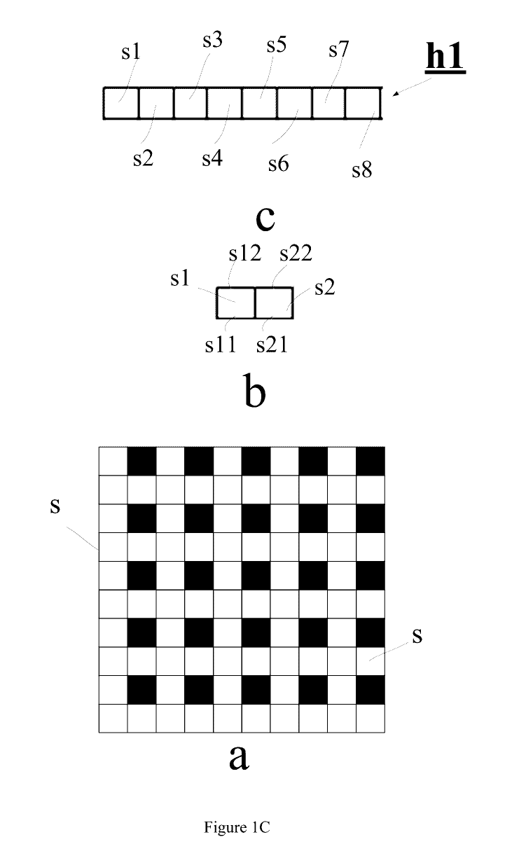

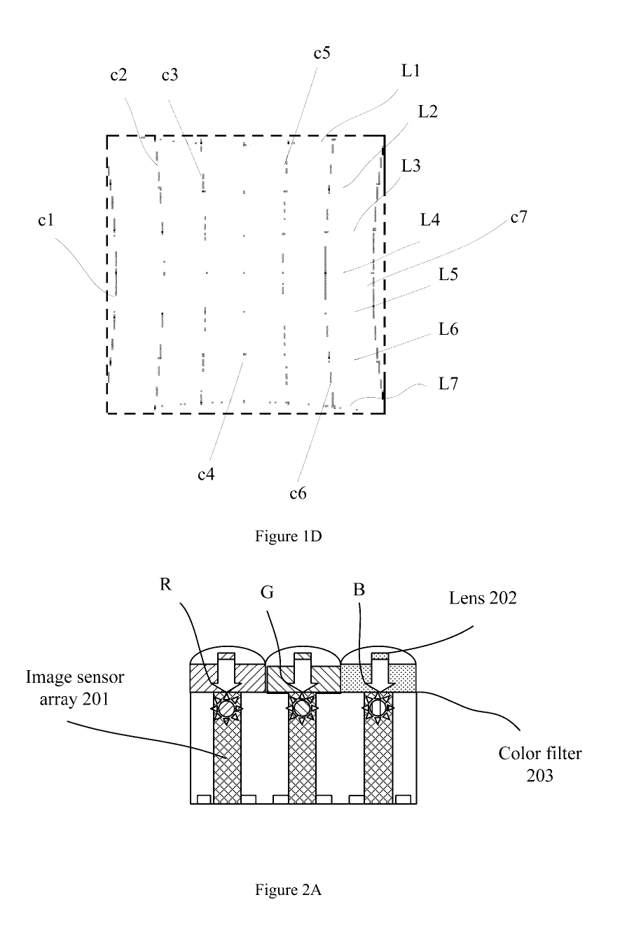

Based on the forgoing description, an embodiment of the present application provides an image sensor array, FIG. 1B is a schematic diagram of composing structure of an image sensor array according to a first embodiment of the present application, as shown in FIG. 1B, the image sensor array comprises M×N image sensors, the M, N being an integer larger than or equal to 1;

the M×N image sensors forms an M-row N-column non-standard rectangular pixel array, wherein the non-standard rectangular pixel array refers to that four edges of the non-standard rectangular are curves; the non-standard rectangular pixel array matches to optical distortion of an associated lens.

In the prior art, pixel sizes in the pixel array are the same, therefore, when one edge of pixels arranged in a row or column is aligned, the other edge of these pixels arranged in a row or column is also aligned, as shown in a to c of FIG. 1C, a of FIG. 1C illustrates a pixel array in the related art, wherein each small rectangle in the pixel array represents a pixel S, since the pixel S itself is a small rectangle, when first edges of these pixels are aligned, then second edges of these pixels are also aligned, wherein the second sides are opposite to the first sides. As shown in b of FIG. 1C, after a first edge s11 of a first pixel s1 is aligned with a first edge s21 of a second pixel s2, naturally, a second edge s12 of the first pixel s1 is also aligned with a second edge s22 of the second pixel s2. As such, first to eighth pixels s1 to s8 can be arranged to form a regular row h1.

In comparison to the prior art, pixel sizes in the pixel array provided by the embodiment of the present application are not the same, FIG. 1D shows a 6×6 non-standard rectangular pixel array, the 6×6 non-standard rectangle pixel array includes in total 7 column edges c1 to c7 composed by columns, and 7 transverse edges L1 to L7 composed by rows, wherein c1 to c7 each may be a curve having a certain curvature, c1 to c3 bend toward a first direction, c4 to c7 bend toward a second direction, the first direction and the second direction are opposite directions, e.g., c1 to c3 bend toward the left, c4 to c7 bend toward the right; L1 to L7 each may be a curve having a certain curvature, L1 to L3 bend toward a third direction, L4 to L7 bend toward a fourth direction, the third direction and the fourth direction are opposite directions, e.g., L1 to L3 bend toward the left, L4 to L7 bend toward the right. As an embodiment, L4 among 7 transverse edges may be a transverse straightedge, and c4 among 7 edges may be a vertical straightedge.

In general, the optical lens is symmetrical, since the non-standard rectangular pixel array matches to optical distortion of an associated lens, the pixel matrix generally is also symmetrical, with FIG. 1D as an example, four pixels ([3, 3], [4, 3], [3, 4], [4, 4]) located in the center of the matrix have the same size, the outermost four pixels ([1, 1], [1, 6], [6, 1], [6, 6]) also have the same size.

In FIG. 1B, each of the small squares in the image sensor array represents an image sensor. FIG. 1B takes three primary colors as an example, as will be appreciated, each color can represent one type of image sensor.

Based on the foregoing embodiment, the embodiment of the present application further provides an arrangement method of an image sensor array, comprising:

forming an M-row N-column non-standard rectangular pixel array with M×N image sensors, wherein the non-standard rectangular pixel array matches to optical distortion of an associated lens, the non-standard rectangular pixel array refers to that four edges of the non-standard rectangular are curves, and the M, N are an integer larger than or equal to 1.

In an embodiment of the present application, pixel sizes in the non-standard rectangular pixel array gradually increase from center to corners.

The new pixel matrix provided by the embodiment of the present application adopts an arrangement method of non-standard rectangular pixel array, and the size of each pixel gradually increases from center to corners; a shape of the entire pixel matrix matches to optical distortion of the lens; in this way, the technical solutions provided by the embodiment of the present application implement adaption between imaging and sensing in terms of imaging shape, make an output in accordance with a current matrix mode at the time of outputting, thus a finally synthesized rectangular picture naturally achieves the function of rectifying distortion.

In addition, the pixel size increases from center to edges, with regard to sensing, pixels at the corners can capture more light, which can be used to remedy problems that a lower amount of light enters from peripheral of the lens and imaging at the peripheral is more obscure, so as to enhance RI and MTF of the corners of the pixel matrix. As can be seen from the above description, the technical solutions provided by the embodiment of the present application have the following advantages: 1) a picture that is naturally rectified and has no distortion can be outputted; 2) RI of the optical system can be effectively improved; and 3) MTF of the corners of the optical system can be improved.

### Second Embodiment

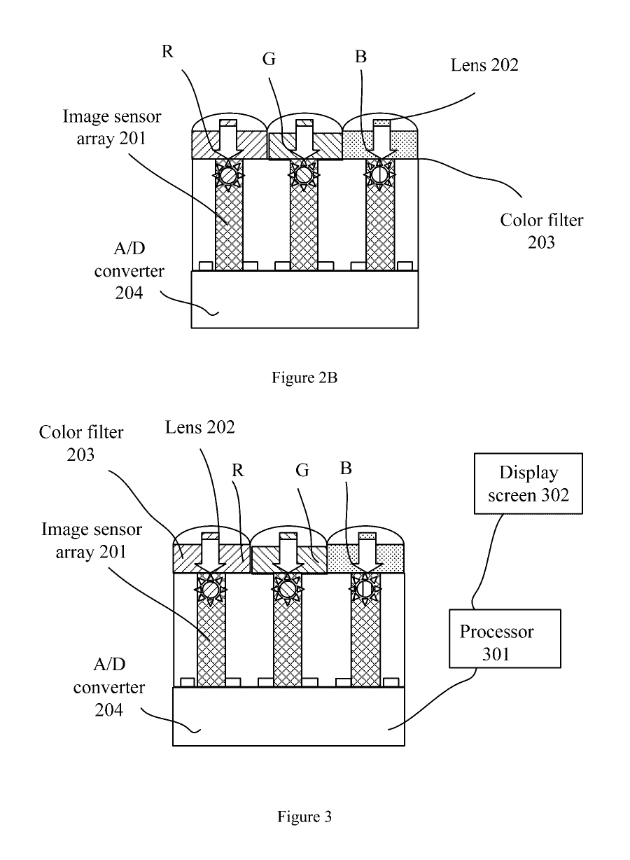

Based on the above First embodiment, an embodiment of the present application provides an image acquisition component, FIG. 2A is a schematic diagram of composing structure of an image acquisition component according to a second embodiment of the present application, as shown in FIG. 2A, the image acquisition component 200 comprises an image sensor array 201 and a lens 202, wherein:

the lens 202 is formed with an optical lens;

the image sensor array 201 includes M×N image sensors, the M, N being an integer larger than or equal to 1;

an M-row N-column non-standard rectangular pixel array is formed with the M×N image sensors, the non-standard rectangular pixel array referring to that four edges of the non-standard rectangular are curves (see FIG. 1B);

the non-standard rectangular pixel array matches to optical distortion of the lens.

In this embodiment of the present application, pixel sizes in the non-standard rectangular pixel array gradually increase from center to corners.

In this embodiment of the present application, as shown in FIG. 2B, the image acquisition component further comprises an analog-to-digital converter 204, wherein:

the lens is formed with an optical and configured to receive incident light reflected by a scenery, the incident light becoming outgoing light after passing through the lens;

the image sensor array is configured to receive the outgoing light from the lens, convert it into charge in accordance with intensity of the outgoing light, and form a current value of an analog signal;

the analog-to-digital converter is configured to convert the current value of the analog signal outputted by the image sensor array into a current value of a digital signal.

As shown in FIG. 2B, light reflected by a scenery is propagated to the lens 202, an optical image generated by the lens is projected onto a surface of the image sensor 201, photodiodes on the image sensor accumulate corresponding charge in accordance with intensity of light, i.e. converting an optical signal to an analog electrical signal, which becomes a digital electrical signal after A/D conversion by the A/D converter 204, wherein a color filter 203 is also provided between the lens 202 and the image sensor 201, the color filter 203 generally adopts the three primary colors (RGB, where R represents red, G represents green, B represents blue) to represent a chromatic image.

### Third Embodiment

Based on the foregoing embodiment, an embodiment of the present application further provides an electronic device, FIG. 3 is a schematic diagram of composing structure of an electronic device according to a third embodiment of the present application, as shown in FIG. 3, the electronic device 300 comprises a processor 301, a display screen 302, and an image acquisition component 200, wherein:

the image acquisition component 200 includes an image sensor array and a lens:

the lens 202 is configured to receive incident light reflected by a scenery, the incident light becoming outgoing light after passing through the lens;

the image sensor array 201 includes M×N image sensors, the M, N being an integer larger than or equal to 1; the M×N image sensors form an M-row N-column non-standard rectangular pixel array, the non-standard rectangular pixel array referring to that four edges of the non-standard rectangular are curves; the non-standard rectangular pixel array matches to optical distortion of the lens;

the image sensor array 201 is configured to receive the outgoing light from the lens, convert it into charge in accordance with intensity of the outgoing light, and form a current value of an analog signal;

the analog-to-digital converter 204 is configured to convert the current value of the analog signal outputted by the image sensor array into a current value of a digital signal, the current value of the analog signal being capable of forming an image;

the processor 301 is configured to display the image on the display screen;

the display screen 302 is configured to display the image.

In this embodiment of the present application, pixel sizes in the non-standard rectangular pixel array gradually increase from center to corners.

### Fourth Embodiment

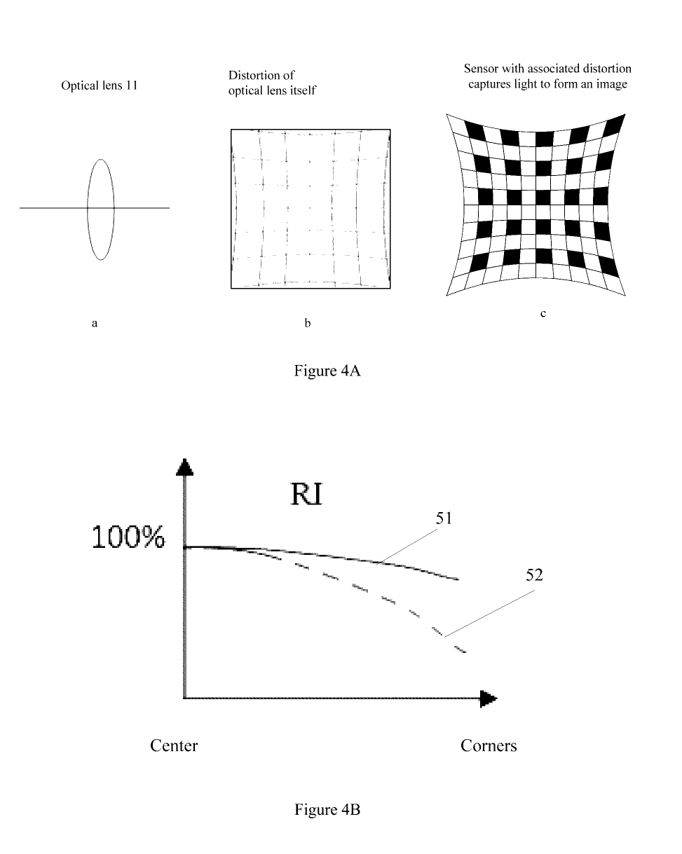

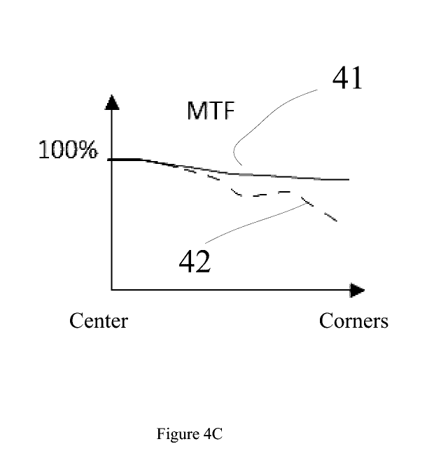

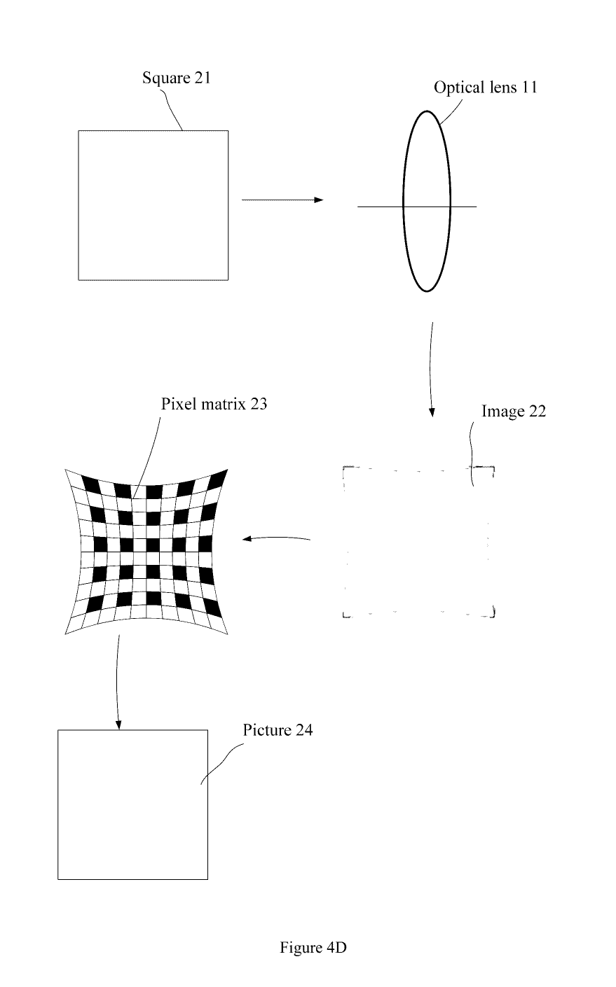

The technical solutions provided by the above embodiments can effectively improve the optical system in the electronic device, in particular, the technical solutions can change the lens limits on distortion in the optical system, to achieve an optimum MTF and RI design, but the shape and size of the pixel array itself need to match the lens distortion. FIG. 4A shows a schematic diagram of matching process of a pixel array and a lens distortion, as shown in FIG. 4A, a square has an image after passing through the optical lens, and imaging matches to the pixel array, wherein the lens is shown in a of FIG. 4A, the image of the square is shown in b of FIG. 4B, and the pixel array is shown in c of FIG. 4A.

Since the pixel size in the pixel array increases from center to periphery, so the light that can be captured also increases from center to periphery, which exactly compensates for a phenomenon that the periphery becomes darker and darker caused by such as shading of the lens, so as to prevent the problem of excessive corner noise caused by ISP processing that is needed subsequently.

FIG. 4B and FIG. 4C illustrate the differences in terms of RI and MTF between the present application and the prior art, wherein dashed lines 42, 52 represent the prior art, and solid lines 41, 51 represent the present application, it can be seen from FIGS. 4B and 4C that, the technical solutions provided by the embodiments of the present application are far superior to the prior art in terms of RI and MTF. Since the pixel size increases along with the field of view, a corresponding spatial frequency decreases, requirement on a blur spot size of an imaging point in the lens reduces, so decrease of the MTF value has been effectively controlled. Thereby, technical solutions provided by the embodiments of the present application can effectively enhance optical shading and resolution.

FIG. 4D is a schematic diagram of a picture outputted by the pixel array according to an embodiment of the present application, as shown in FIG. 4D, a square pattern 21 will have an image 22 after passing through an optical lens 11, the pattern 21, a square originally, has distortion after passing through the optical lens 11, since four edges of the image 22 are no more straight lines and two adjacent edges no more intersect with a right angle, the image 22 is no more a square. But a picture outputted after the image 22 passes through the pixel matrix provided by the embodiments of the present application remains a square; so, it can be seen that the image outputted by the pixel matrix can rectify lens distortion.

As will be appreciated, “one embodiment” or “an embodiment” referred throughout the specification means that particular features, structures, or characteristics associated with the embodiment are included in at least one embodiment of the present application. Thus, “one embodiment” or “an embodiment” appearing throughout the specification does not necessarily refer to the same embodiment. Furthermore, the particular features, structures, or characteristics may be combined in any suitable manner in one or more embodiments. It should be understood that, in various embodiments of the present application, sequence numbers of the above respective processes do not mean the execution sequence, the execution sequence of the respective processes should be decided by their functions and internal logic, without making limitations to the implementation processes of the embodiments of the present application.

The above described are merely specific implementations of the present disclosure, however, the protection scope of the present disclosure is limited thereto, modifications or replacements that are easily conceivable for those skilled in the art within the technique range disclosed in the present disclosure should all fall into the protection scope of the present disclosure. Therefore the protection scope of the present disclosure should be determined based on what is claimed in the claims.

1. An arrangement method of an image sensor array comprising forming an M-row N-column non-standard rectangular pixel array with M×N image sensors, wherein the non-standard rectangular pixel array matches an optical distortion of an associated lens, and the non-standard rectangular pixel array refers to that four edges of the non-standard rectangular are curves, and the M, N are an integer larger than or equal to 1.

2. The method according to claim 1, wherein pixel sizes in the non-standard rectangular pixel array gradually increase from a center to corners.

3. An image sensor array, comprising M×N image sensors, wherein
M, N are an integer larger than or equal to 1;
the M×N image sensors form an M-row N-column non-standard rectangular pixel array, the non-standard rectangular pixel array referring to that four edges of the non-standard rectangular are curves;
the non-standard rectangular pixel array matches to optical distortion of an associated lens.

4. The image sensor array according to claim 3, wherein pixel sizes in the non-standard rectangular pixel array gradually increase from a center to corners.

5. An image acquisition component, comprising an image sensor array and a lens, wherein:
the lens is formed with an optical lens;
the image sensor array includes M×N image sensors, M, N being an integer larger than or equal to 1;
the M×N image sensors form an M-row N-column non-standard rectangular pixel array, the non-standard rectangular pixel array referring to that four edges of the non-standard rectangular are curves;
the non-standard rectangular pixel array matches to optical distortion of the lens.

6. The image acquisition component according to claim 5, wherein pixel sizes in the non-standard rectangular pixel array gradually increase from a center to corners.

7. The image acquisition component according to claim 5, further comprising an analog-to-digital converter, wherein:
the lens is formed with an optical lens and configured to receive incident light reflected by a scenery, the incident light becoming outgoing light after passing through the lens;
the image sensor array is configured to receive the outgoing light from the lens, convert it into charge in accordance with intensity of the outgoing light, and form a current value of an analog signal;
the analog-to-digital converter is configured to convert the current value of the analog signal outputted by the image sensor array into a current value of a digital signal.

8. An electronic device, comprising a processor, a display screen, and an image acquisition component, wherein:
the image acquisition component comprises an image sensor array, a lens, and an analog-to-digital converter:
the lens is configured to receive incident light reflected by a scenery, the incident light becoming outgoing light after passing through the lens;
the image sensor array comprises M×N image sensors, M, N being an integer larger than or equal to 1; the M×N image sensors form an M-row N-column non-standard rectangular pixel array, the non-standard rectangular pixel array referring to that four edges of the non-standard rectangular are curves; the non-standard rectangular pixel array matches to optical distortion of the lens;
the image sensor array is configured to receive the outgoing light from the lens, convert it into charge in accordance with intensity of the outgoing light, and form a current value of an analog signal;
the analog-to-digital converter is configured to convert the current value of the analog signal outputted by the image sensor array into a current value of a digital signal, the current value of the analog signal being capable of forming an image;
the processor is configured to display the image on the display screen; and
the display screen is configured to display the image.

9. The electronic device according to claim 8, wherein pixel sizes in the non-standard rectangular pixel array gradually increase from a center to corners.
